(19) United States
(12) Patent Application Publication
(10) Pub. No.: US 2012/0139907 A1
(43) Pub. Date: Jun. 7, 2012

(54) 3 DIMENSIONAL (3D) DISPLAY SYSTEM OF RESPONDING TO USER MOTION AND USER INTERFACE FOR THE 3D DISPLAY SYSTEM

(75) Inventors: Dong-ho LEE, Seoul (KR); Hee-seob RYU, Hwaseong-si (KR); Yeun-bae KIM, Seongnam-si (KR); Seung-kwon PARK, Yongin-si (KR); Seong-hun JEONG, Suwon-si (KR)

(73) Assignee: SAMSUNG ELECTRONICS CO., LTD., Suwon-si (KR)

(21) Appl. No.: 13/293,690

(22) Filed: Nov. 10, 2011

(30) Foreign Application Priority Data
Dec. 6, 2010 (KR) 10-2010-0123556

(51) Int. Cl. G06T 15/00

(52) U.S. Cl. 345/419

(57) ABSTRACT

A three dimensional (3D) display system is provided, which includes a screen which displays a plurality of objects with different depth values from each other, the plurality of objects having circulating relationship according to the corresponding depth values thereof, a motion detecting unit which senses a user motion with respect to the screen, and a control unit which measures a user motion distance in z-axis direction with respect to the screen according to the user motion, using an output from the motion detecting unit, selects one from among the plurality of objects in accordance with the measured user motion distance in the z-axis direction, controls the depth value of the one selected object so that the one selected object is displayed in front of the plurality of objects on the screen, and controls the depth values of a rest of the plurality of objects according to the circulating relationship.

### CROSS-REFERENCE TO RELATED APPLICATION

This application claims priority from Korean Patent Application No. 10-2010-0123556, filed on Dec. 6, 2010 in the Korean Intellectual Property Office, the disclosure of which is incorporated herein by reference in its entirety.

### BACKGROUND

1. Field

Methods and apparatuses consistent with exemplary embodiments relate to selecting an object in a user's 3 dimensional (3D) display system and more particularly, to a method and system for navigating objects displayed on the 3D display system through user motion.

2. Description of the Related Art

User Interface (UI) provides temporary or continuous access to enable communication between a user and objects, systems, apparatuses or programs. The UI may include a physical interface or a software interface.

If a user input is made through the UI, various electronic devices including TVs or game players provide an output according to the user's input. For example, the output may include volume control, or control of an object being displayed.

UIs that can respond to the user's motion at remote distance have been continuously researched and developed to provide more convenience to users of the electronic apparatuses including TVs and game players.

### SUMMARY

Exemplary embodiments of the present inventive concept overcome the above disadvantages and/or other disadvantages not described above. Also, the present inventive concept is not required to overcome the disadvantages described above, and an exemplary embodiment of the present inventive concept may not overcome any of the problems described above.

According to one exemplary embodiment, a three dimensional (3D) display system is provided, which may include a screen which displays a plurality of objects having different depth values from each other, the plurality of objects having a circulating relationship according to the corresponding depth values thereof, a motion detecting unit which senses a user motion with respect to the screen, and a control unit which measures a user motion distance in a z-axis direction with respect to the screen according to the user motion, using an output from the motion detecting unit, selects one from among the plurality of objects in accordance with the measured user motion distance in the z-axis direction, controls the depth value of the one selected object so that the selected object is displayed in front of the plurality of objects on the screen, and controls the depth values of a rest of the plurality of objects according to the circulating relationship.

According to another exemplary embodiment, a three dimensional (3D) display system is provided, which may include a screen which displays a plurality of objects having different depth values from each other, a motion detecting unit which senses a user motion with respect to the screen, and a control unit which measures a user motion distance in a z-axis direction with respect to the screen according to the user motion, using an output from the motion detecting unit, and selects at least one object from among the plurality of objects in accordance with the measured user motion distance in the z-axis direction with respect to the screen. The control unit may select the at least one object from among the plurality of objects in proportion to the measured user motion distance in the z-axis direction according to the user motion.

The control unit may also control the depth value of the at least one selected object. Further, the control unit may control the depth value of the at least one selected object so that the selected object is displayed in front of the plurality of objects on the screen.

According to an aspect of the exemplary embodiment, the plurality of objects may have a circulating relationship according to the depth values thereof, and if the control unit controls the depth value of the at least one selected object, the control unit may control the depth values of a rest of the plurality of objects according to the circulating relationship.

According to an aspect of the exemplary embodiment, the plurality of objects may form an imaginary ring according to the depth values, and if the at least one object is selected, the at least one object is displayed in front of the plurality of objects, and an order of a rest of the plurality of objects is adjusted according to the imaginary ring.

According to another aspect of the exemplary embodiment, the control unit highlights the at least one selected object. The control unit may change a transparency of the at least one selected object, or change the transparency of an object which has the greater depth value than that of the at least one selected object.

According to another aspect of the exemplary embodiment, the 3D display system may detect a change in user's hand shape, and according to the change in the user's hand shape, perform an operation related to the selected object. For example, the control unit may select an object if the user's hand shape is gesturing a ‘paper’ sign, and the control unit may perform an operation of the selected object, if the user's hand shape is gesturing a ‘rock’ sign. Further, the plurality of objects may form two or more groups, and the screen may display the two or more groups concurrently. The control unit may measure a user motion distance in x-axis and y-axis directions with respect to the screen according to the user motion, using an output from the motion detecting unit, and select at least one group from among the two or more groups according to the measured user motion distance in x-axis and y-axis directions.

According to another exemplary embodiment, a three dimensional (3D) display system is provided, which may include a screen which displays a plurality of object groups concurrently, the plurality of object groups each including a plurality of objects having different depth values from each other, a motion detecting unit which senses a user motion with respect to the screen, and a control unit which measures a user motion distance in x-axis and y-axis directions with respect to the screen according to the user motion, using an output from the motion detecting unit, selects one object group from among the plurality of object groups according to the measured user motion distance in the x-axis and y-axis directions, measures a user motion distance in z-axis direction with respect to the screen according to the user motion, using an output from the motion detecting unit, and selects at least one object from among the plurality of objects of the selected object group according to the measured user motion distance in the z-axis direction. The control unit may measure the user motion distance in the x-axis and y-axis directions with respect to the screen according to the user motion of one hand of the user, and measure the user motion distance in the z-axis direction with respect to the screen according to the user motion of the other hand of the user.

According to another exemplary embodiment, a three dimensional (3D) display method is provided, which may include displaying a plurality of objects with different depth values from each other, sensing a user motion with respect to the screen, and measuring a user motion distance in a z-axis direction with respect to the screen according to the user motion, and selecting at least one object from among the plurality of objects in accordance with the measured user motion distance in the z-axis direction. The selecting the at least one object may include selecting the at least one object from among the plurality of objects in proportion to the measured user motion distance and a direction of the user motion in the z-axis direction with respect to the screen according to the user motion. The 3D display method may additionally include controlling the depth value of the at least one selected object.

According to an aspect of another exemplary embodiment, the 3D display method may additionally include controlling the depth value of the at least one selected object so that the selected object is displayed in front of the plurality of objects on the screen. The plurality of objects may have a circulating relationship according to the depth values thereof, and if the depth value of the at least one selected object is controlled, the 3D display method may additionally include controlling the depth values of a rest of the plurality of objects according to the circulating relationship.

According to an aspect of another exemplary embodiment, the 3D display method may additionally include highlighting the at least one selected object. The 3D display method may additionally include changing a transparency of the at least one selected object, or changing the transparency of an object which has the greater depth value than that of the at least one selected object.

According to an aspect of another exemplary embodiment, the 3D display method may additionally include detecting a change in a user's hand shape, and selecting an object according to the change in the user's hand shape. The controlling may include controlling a control unit to select the object if the user's hand shape is gesturing a ‘paper’ sign, and performing an operation related to the selected object if the user's hand shape is gesturing a ‘rock’ sign. However, it is noted that the selection of the object is not limited to the user's hand forming these signs and other signs or shapes may be utilized for selecting the objects. Further, the plurality of objects may form two or more groups, and the 3D display method may additionally include displaying the two or more groups concurrently on the screen, measuring a user motion distance in x-axis and y-axis directions according to the sensed user motion, and selecting at least one group from among the two or more groups according to the user motion distance in x-axis and y-axis directions.

According to another exemplary embodiment, a three dimensional (3D) display method is provided, which may include displaying a plurality of object groups concurrently, the plurality of object groups each including a plurality of objects having different depth values from each other, sensing a user motion with respect to the screen, and measuring a user motion distance in x-axis and y-axis directions with respect to the screen according to the sensed user motion, selecting one group from among the plurality of object groups according to the measured user motion distance in the x-axis and y-axis directions, and selecting at least one object from among the plurality of objects of the selected object group according to the measured user motion distance in z-axis direction.

According to an aspect of another exemplary embodiment, the 3D display method may include measuring the user motion distance in x-axis and y-axis directions according to the user motion with respect to the screen according to a motion of one hand of the user, and measuring the user motion distance in z-axis direction with respect to the screen according to the user motion according to a motion of the other hand of the user.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 illustrates a block diagram of a three dimensional (3D) display system according to an exemplary embodiment;

FIG. 2 illustrates a user making motion with respect to a screen according to an exemplary embodiment;

FIG. 3 illustrates a sensor according to an exemplary embodiment;

FIG. 4 illustrates an image frame and objects on the image frame, according to an exemplary embodiment;

FIG. 5 illustrates four layers having different depth values from each other according to an exemplary embodiment;

FIG. 6 illustrates another aspect of a screen and of objects which are displayed on the screen and which have different depth values from each other, according to an exemplary embodiment;

FIG. 7 illustrates overviews including screen and plurality of objects according to the user motion;

FIG. 8 illustrates changes in objects having different depth values from each other on a screen;

FIG. 9 illustrates various overviews including screen and plurality of object groups according to a user motion;

FIG. 10 is a flowchart illustrating operation of selecting any one of the plurality of objects displayed on a screen;

FIG. 11 is a flowchart illustrating operation of selecting one from among a plurality of objects displayed in two or more groups on the screen according to the user motion;

FIG. 12 illustrates an example of circulating relationship according to depth values of the plurality of objects; and

FIG. 13 illustrates other overviews including a screen and plurality of objects according to a user motion.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

Further, unless otherwise specified, all the nouns written in singular forms throughout the description and the accompanying claims are intended to encompass a plurality of forms. Further, the term ‘and’ used throughout the specification should be understood to encompass all the possible combination of one or more items listed in the disclosure.

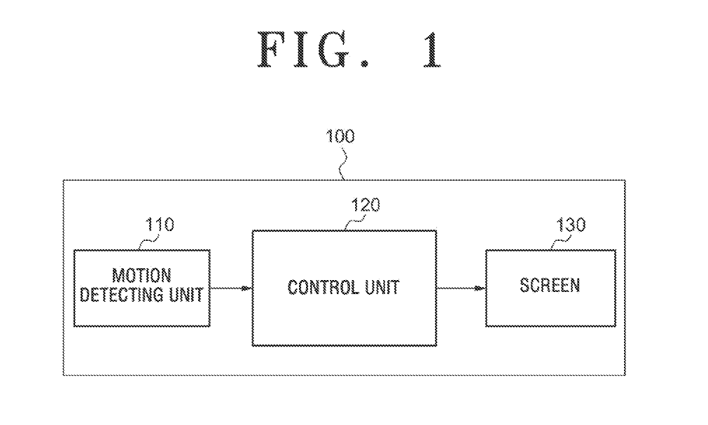

FIG. 1 illustrates a block diagram of a three dimensional (3D) display system according to an exemplary embodiment. Referring to FIG. 1, the 3D display system 100 may include a screen 130 displaying a plurality of objects having different depth values from each other, a motion detecting unit or depth sensor 110 sensing a user motion with respect to the screen 130, and a control unit 120 measuring a user motion distance in the z axis with respect to the screen 130, and selecting at least one of the plurality of objects corresponding to the user motion distance in the z axis.

The motion detecting unit 110 may detect a user motion and acquire raw data. The motion detecting unit 110 may generate an electric signal in response to the user motion. The electric signal may be analog or digital. The motion detecting unit 110 may be a remote controller including an inertial sensor or an optical sensor. The remote controller may generate an electric signal in response to the user motion such as the user motion in the x axis, the user motion in the y axis, and the user motion in the z axis with respect to the screen 130. If a user grips and moves the remote controller, the inertial sensor located in the remote controller may generate an electric signal in response to the user motion in the x axis, y axis, or z axis with respect to the screen 130. The electric signal in response to the user motion in the x axis, y axis, and z axis with respect to the screen 130 may be transmitted to the 3D display system through wire or wireless telecommunication.

The motion detecting unit 110 may also be a vision sensor. The vision sensor may photograph the user. The vision sensor may be included in the 3D display system 100 or may be provided as an attached module.

The motion detecting unit 110 may acquire user position and motion. The user position may include at least one of information including coordinates in the vertical direction (i.e., x-axis) of an image frame with respect to the motion detecting unit 110, coordinates in the horizontal direction (i.e., y-axis) of an image frame with respect to the motion detecting unit 110, and depth information (i.e., coordinates in the z-axis) of an image frame with respect to the motion detecting unit 110 indicating a distance of the user to the motion detecting unit 110. The depth information may be obtained by using the coordinate values in the different directions of the image frame. For instance, the motion detecting unit 110 may photograph the user and may input an image frame including user depth information. The image frame may be divided into a plurality of areas, and at least two of the plurality of areas may have different thresholds from each other. The motion detecting unit 110 may determine coordinates in the vertical direction and in the horizontal direction from the image frame. The motion detecting unit 110 may also determine depth information of a distance from the user to the motion detecting unit 110. A depth sensor, a two dimensional camera, and 3D dimensional camera including a stereoscopic camera may be utilized as the motion detecting unit 110. The camera (not illustrated) may photograph the user and save the image frames.

A control unit 120 may calculate user motion distance by using the image frames. The control unit 120 may detect the user position, and may calculate the user motion distance, for instance the user motion distance in the x-axis, y-axis, and z-axis with respect to the screen 130. The control unit 120 may generate motion information from the image frames based on the user position so that an event is generated in response to the user motion. Also, the control unit 120 may generate an event in response to the motion information.

The control unit 120 may calculate a size of the user motion by utilizing at least one of the stored image frames or utilizing data of the user position. For instance, the control unit 120 may calculate the user motion size based on a line connecting the beginning and ending of the user motion or based on a length of an imaginary line drawn based on the average positions of the user motion. If the user motion is acquired through the plurality of image frames, the control unit 120 may calculate the user position based on at least one of the plurality of image frames corresponding to the user motion, or a center point position calculated by utilizing at least one of the plurality of image frames, or a position calculated by detecting moving time per intervals. For instance, the user position may be a position in the starting image frame of the user motion, a position in the last image frame of the user motion, or a center point between the starting and the last image frame.

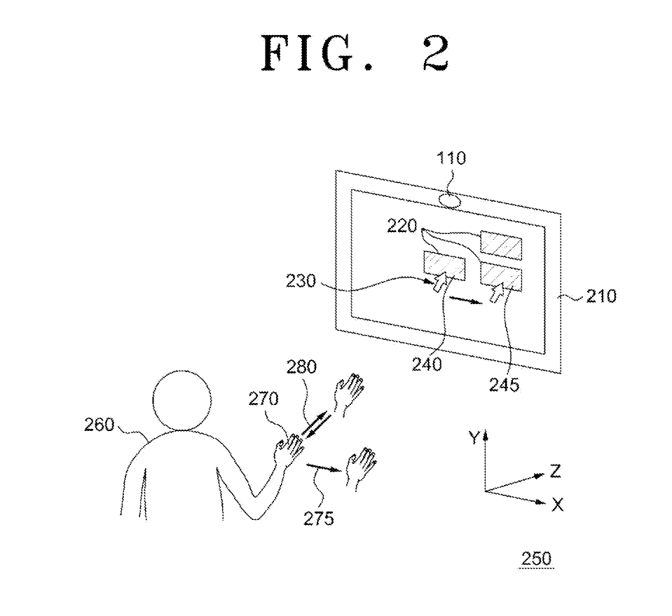

The control unit 120 may generate user motion information based on the user motion so that an event is generated in response to the user motion. The control unit may display a menu 220 on a screen in response to the user motion as illustrated in FIG. 2.

Referring to FIGS. 2 to 4, the operation of the respective components will be explained in further detail below.

FIG. 2 illustrates a user 260 making a motion with respect to the screen 130 according to an exemplary embodiment. In particular, the user 260 moves his/her hand 270 in a z-axis direction 280 with respect to the plane 250 to select one of the items 240 of the menu 220. The user 260 can select one of the items 240 in the menu 220 by controlling, for example, a cursor 230. However, it is noted that the use of a cursor 230 is just one example of many forms how a user can point or select an item from the menu 220. In addition, the user 260 may move the selected item 240 to a new position 245 on the screen 130 of the display system by moving his/her hand in an x-axis direction 275 with respect to the plane 250.

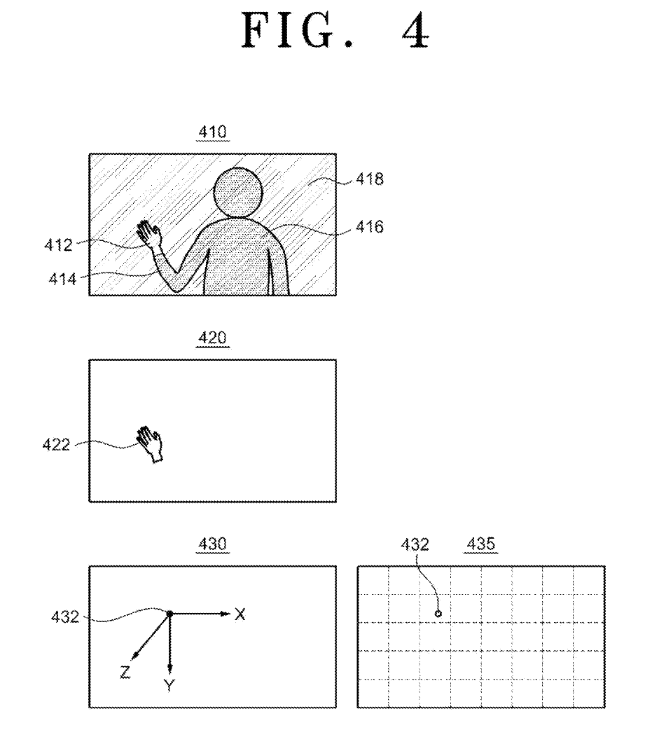

The 3D display system 210 shown in FIG. 2 may include a television, a game unit, and/or an audio. The motion detecting unit 110 may detect an image frame 410 as shown in FIG. 4 including a hand 270 of a user 260. As noted above, the motion detecting unit 110 may be a vision sensor, and the vision sensor may be included in the 3D display system or may be provided as an attached module. The image frame 410 may include an outline of objects having depth such as contours and depth information in response to the outline. The outline 412 corresponds to the hand 270 of the user 260, and may have depth information of the distance from the hand 270 to the motion detecting unit 110. An outline 414 corresponds to the arm of the user 260, and an outline 416 corresponds to a head and an upper torso of the user 260. An outline 418 corresponds to a background of the user 260. The outline 412 and the outline 418 may have different depth information from each other.

The control unit 120 shown in FIG. 1 may detect the user position by utilizing an image frame 410 shown in FIG. 4. The control unit 120 may detect the user 412 on the image frame 410 using information from the image frame 410. Also, the control unit 120 may display different shapes of the user 412 on the image frame 410. For instance, the control unit 120 may display at least one point, line or surface representing the user 422 on the image frame 420.

Also, the control unit 120 may display a point representing the user 432 on the image frame 430, and may display 3D coordinates of the user position in the image frame 435. The 3D coordinates may include x, y, and z axes, and the x-axis corresponds to the horizontal line of the image frame, and the y-axis corresponds to the vertical line of the image frame. The z-axis corresponds to another line of the image frame including values having depth information.

The control unit 120 may detect the user position by utilizing at least two image frames and may calculate the user motion size. Also, the user motion size may be displayed by x, y, and z axes.

The control unit 120 may receive signals from the motion detecting unit 110 and calculate user motion with respect to at least one of the x, y and z axes. The motion detecting unit 110 outputs signals to the control unit 120, and the control unit 120 calculates the user motion on the 3D dimension by analyzing the received signals. The signals may include x, y, and z axis components, and the control unit 120 may measure the user motion by measuring the signals at predetermined time intervals and measuring changes of values in response to the x, y, and z axes components. The user motion may include the motion of a user's hands. If a user moves his/her hands, the motion detecting unit 110 outputs signals in response to the motion of the user's hands, and the control unit 120 may receive the signals and determine the changes, directions, and speeds of the motion. The user motion may also include changes in the user hand shape. For example, if a user forms a fist, the motion detecting unit 110 may output signals and the control unit 120 may receive the signals.

The control unit 120 may select at least one of the plurality of 3D objects so that depth value in response to the selected 3D objects decreases as the user motion distance with respect to the z-axis increases. The 3D objects having depth values are displayed on the 3D display system. The user motion distance of the user motion may include a user motion distance of an effective motion toward the screen. The user motion distance of the effective motion is one of the user motion distances with respect to the x, y, and z axes. A user motion may include all of the x, y, and z axes. But, to select an object having different depth values from each other, only the user motion distance with respect to the z-axis may be calculated.

The control unit 120 may select at least one of the plurality of objects, in response to the user motion, on the screen 130, and may provide visual feedback. The visual feedback may change transparency, depth, brightness, color, and size of the selected objects or others.

The control unit 120 may display contents of the selected objects or may play contents. Playing contents may include displaying videos, still videos, and texts stored in a storage unit on a screen, displaying signals from the broadcasting on a screen, and enlarging and displaying images of the screen. The screen 130 may be a display unit. For instance, an LCD, a CRT, a PDP, or an LED may be the screen.

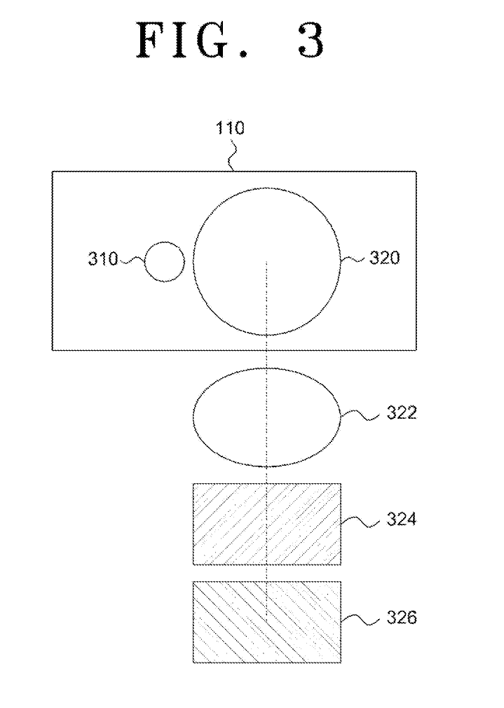

FIG. 3 illustrates a depth sensor or motion detecting unit 110. The depth sensor 110 includes an infrared receiving unit 310, an optical receiving unit 320, a lens 322, an infrared filter 324, and an image sensor 326. The infrared receiving unit 310 and the optical receiving unit 320 may be placed adjacent to each other. The depth sensor 110 may have a field of view as a unique value according to the optical receiving unit 320. The infrared ray which is transmitted by the infrared receiving unit 310 is reflected after reaching the objects including an object placed at a front side thereof, and the reflected infrared ray may be transmitted to the optical receiving unit 320. The infrared ray passes through the lens 322 and the infrared filter 324 and reaches the image sensor 326. The image sensor 326 may convert the received infrared ray into an electric signal to obtain an image frame. For example, the image sensor 326 may be a Charge Coupled Device (CCD) or a Complementary Metal Oxide Semiconductor (CMOS) etc. The outline of an image frame may be obtained according to the depth of the objects and each outline may be processed by signals to include the depth information. The depth information may be acquired by using time of flight of the infrared ray transmitted from the infrared receiving unit 310 to the optical receiving unit 320. In addition, an apparatus detecting the location of the object by receiving/transmitting the ultrasonic waves or the radio waves may also acquire the depth information by using the time of flight of the ultrasonic waves or the radio waves.

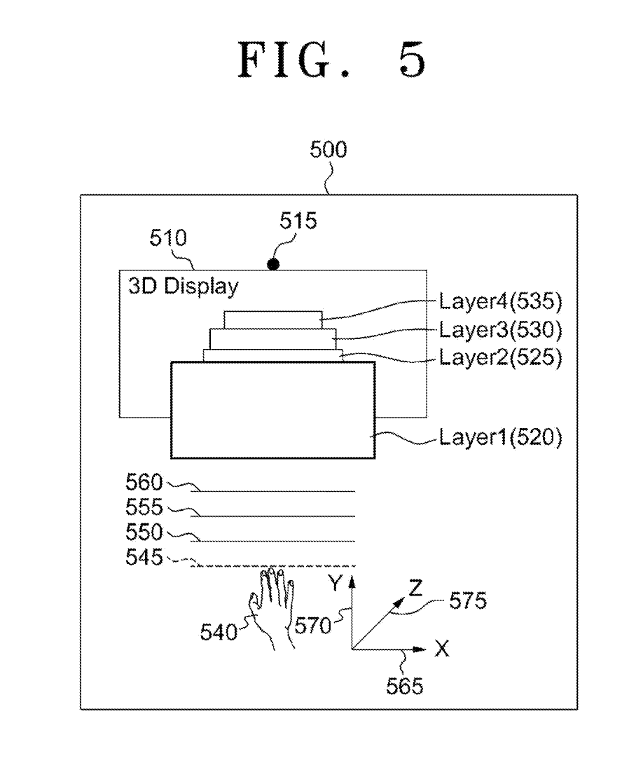

FIG. 5 illustrates four layers having different depth values from each other according to an exemplary embodiment.

Referring to FIG. 5, a 3D display system 500 may include a screen 510 displaying a plurality of objects 520, 525, 530, 535 having different depth values from each other, a motion detecting unit 515 sensing a user motion with respect to the screen 510, and a control unit (not illustrated) measuring a user motion distance in the z-axis 575 with respect to the screen 510 in response to the user motion by utilizing the output of the motion detecting unit 515, and selecting at least one of the plurality of objects in response to the user motion in the z axis. The screen 510 displays a plurality of objects 520, 525, 530, 535. The plurality of objects 520, 525, 530, 535 have different depth values from each other. The object 520 is placed at the front of the screen, and has the maximum depth value. The object 525 is placed in back of the object 520, and has the second-largest depth value. The object 530 is placed in back of the object 525, and has the third-largest depth value. The object 535 is placed nearest to the screen, and has the minimum depth value. The depth value decreases from the object 520, the object 525, the object 530, and the object 535. For instance, if a screen area of the screen 510 has a depth value of 0, the object 520 may have a depth value of 40, the object 525 may have a depth value of 30, the object 530 may have a depth value of 20, and the object 535 may have a depth value of 10. Also, the plurality of object 520, 525, 530, 535 having different depth values from each other may be displayed on hypothetical layers. The object 520 may be displayed on a layer 1, the object 525 may be displayed on a layer 2, the object 530 may be displayed on a layer 3, and the object 535 may be displayed on a layer 4.

The layers are hypothetical planes which may have unique depth values. The objects with different depth values may be displayed on the layers having corresponding depth values, respectively. For instance, the object having a depth value of 10 may be displayed on a layer having a depth value of 10, and the object having a depth value of 20 may be displayed on a layer having a depth value of 20.

According to an exemplary embodiment, a user motion may be a hand 540 motion. A user motion may also be another body part motion. A user motion may also be a motion on a 3D space. The control unit (not illustrated) divides a user motion into x-axis 565, y-axis 570, and z-axis 575 information, and measures the user motion distance. The control unit may select the user motion in the z-axis and at least one 3D object from the plurality of objects according to the user motion distance in the z-axis.

The z-axis, perpendicular to the screen area, may be divided into +z axis approaching the screen and −z-axis moving away from the screen. If a user moves his/her hands in the z direction, the hands may be closer or further from the screen. If a user hand 540 hypothetically contacts one line of the hypothetical lines 545, 550, 555, 560, by moving his/her hand in the z-axis direction, one of the corresponding layers 520, 525, 530, 535 may be selected. Hypothetical lines may be selected if a user's hand is placed near the lines. In other words, if a user motion distance of the user hand is within a predetermined range of the hypothetical line, it may be considered that the hand contacts the corresponding hypothetical line. For instance, if a hypothetical line 545 is 2 meters away from the screen, a hypothetical line 550 is 1.9 meters away from the screen, a hypothetical line 555 is 1.8 meters away from the screen, and a hypothetical line 560 is 1.7 meters away from the screen, and if a user hand is between 2.4 meters and 1.96 meters away from the screen, the layer 2 may be selected. Thus, even if a user's hand is not exactly aligned on the line, it may be considered that a user contacts the hypothetical line.

The control unit may measure a user motion distance with respect to the z axis and moving direction such as +z axis or −z axis, and may select at least one layer from the layers 520, 525, 530, 535 having different depth values from each other. The control unit selects another layer if the user motion distance to the z axis exceeds a predetermined range of the hypothetical line. For instance, if a user's hand 540 is on the hypothetical line 545, the layer 1 520 is selected. If a user moves his/her hand closer to the screen, i.e., to +z axis 575 toward the hypothetical line 550, the layer 2 525 is selected. In proportion to the user motion distance and direction to the z axis, at least one of the layers 520, 525, 530, 535 may be selected.

The motion detecting unit 515 detects motion of the user's hand 540 and transmits the output signals. The motion detecting unit 515 may be a vision sensor. The motion detecting unit 515 may be included in the 3D display system or may be provided as an attached module. The control unit (not illustrated) may receive signals from the motion detecting unit 515 and measure user motion distance of the user motion in the x, y, and z axes. The control unit may control selecting at least one of the plurality of objects 520, 525, 530, 535 having different values displayed on the screen 510 in response to the user motion in the z-axis.

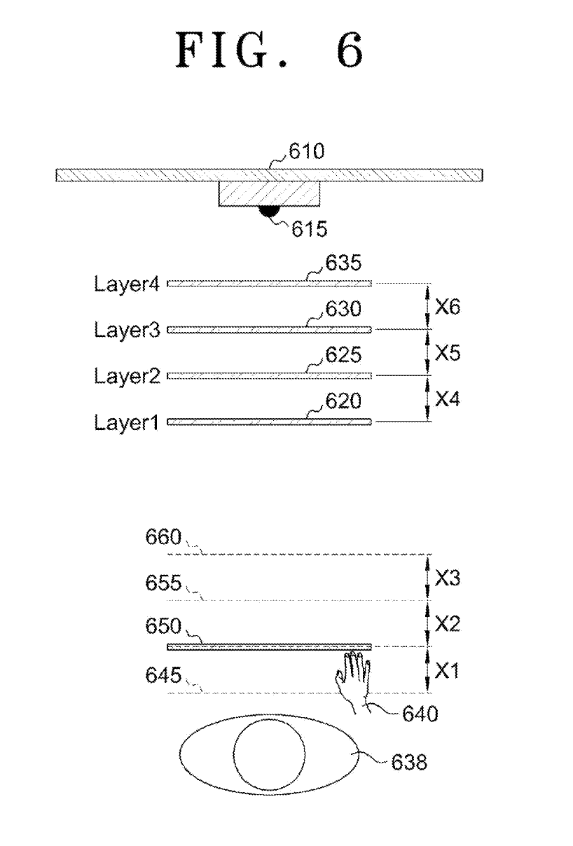

FIG. 6 illustrates another aspect of a screen and of objects which are displayed on the screen and which have different depth values from each other.

Referring to FIG. 6, the 3D display system includes a screen 610 displaying a plurality of objects 620, 625, 630, 635 having different depth values from each other, a motion detecting unit 615 sensing a user motion with respect to the screen 610, and a control unit (not illustrated) measuring a user motion distance in the z axis with respect to the screen 610 by utilizing outputs from the motion detecting unit 615, and selecting at least one of the plurality of objects in response to the user motion distance in the z axis with respect to the screen 610. The object 620 is on a layer 1. The object 625 is on a layer 2. The object 630 is on a layer 3. The object 635 is on a layer 4. The distance between the layer 1 620 and the layer 2 625 is X4. The distance between the layer 2 625 and the layer 3 630 is X5. The distance between the layer 3 630 and the layer 4 635 is X6. If a user 638 moves a hand 640 in front of the screen 610, the motion detecting unit 615 senses a user motion. The user motion on a 3D area may be in any direction of x, y, and z axes, and the motion detecting unit 615 may detect and output electric signals to the control unit. If a user's hand 640 moves in front of the screen 610, the control unit measures the user motion distances with respect to X1, X2, X3. The layers 620, 625, 630, 635 may be selected in response to the user motion distances X1, X2, X3. For instance, if a user moves the hand 640 to the position 645, the layer 1 620 may be selected and a user may perform an operation with respect to the selected object on the layer 1. If a user moves the hand 640 to the position 650, the layer 2 625 may be selected and a user may perform an operation with respect to the selected object on the layer 2. If a user moves the hand 640 to the position 655, the layer 3 630 may be selected and a user may perform an operation with respect to the selected object on the layer 3. If a user moves the hand 640 to the position 660, the layer 4 635 may be selected and a user may perform an operation with respect to the selected object on the layer 4. The user motion distances X1, X2, X3 of the user hand 640 have linear relationship with the distances X4, X5, X6 between the layers 620, 625, 630, 635, which may be explained as formula 1.

X1=A*X4

X2=A*X5

X3=A*X6 Formula 1

where, A may be any positive real number, for instance, one of 0.5, 1, 2, 3 and so on.

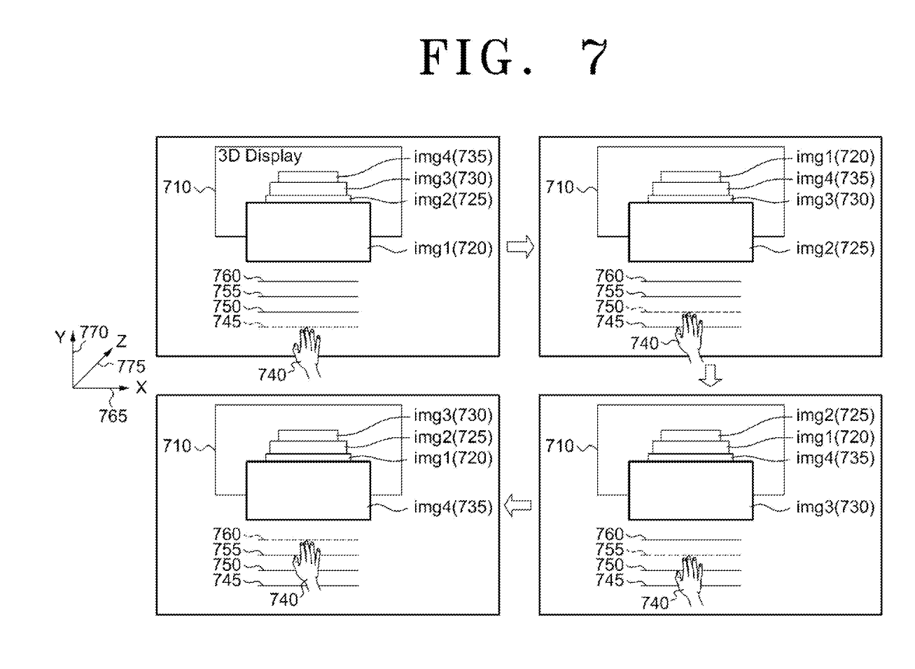

FIG. 7 illustrates various screens and a plurality of selected objects on the various screens according to the user motion.

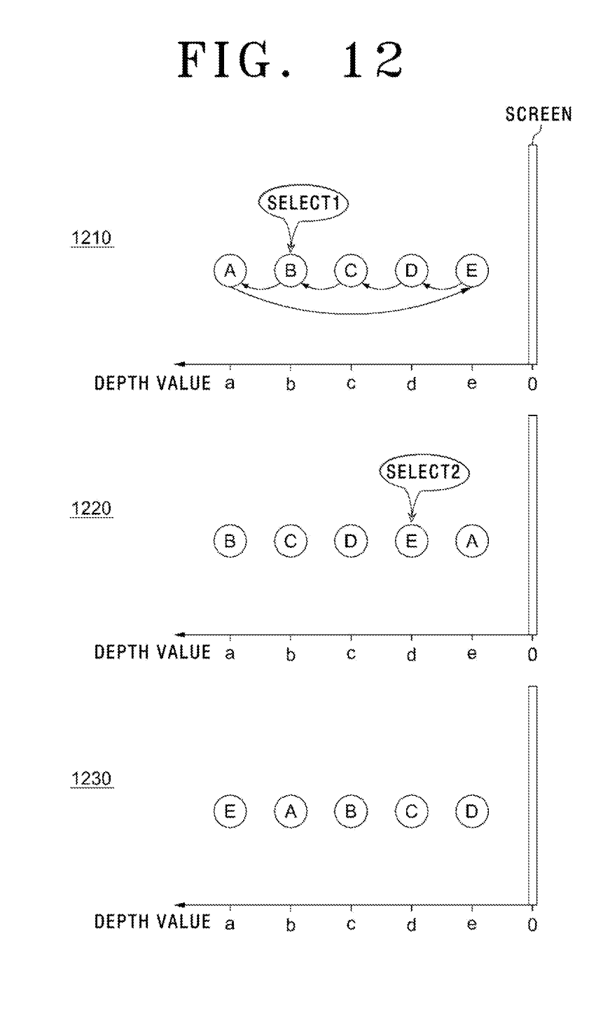

A 3D display system may include a screen 710 displaying a plurality of objects 720, 725, 730, 735 having different depth values from each other and having circulating relationships according to the depth values, a motion detecting unit (not illustrated) sensing a user motion with respect to the screen, and a control unit measuring a user motion distance in the z-axis in response to the user motion by utilizing an output form the motion detecting unit, selecting at least one of the plurality of objects in response to the user motion distance in the z-axis, controlling depth values of the selected object to display the selected object in front of the other objects, and controlling depth values of the other objects according to the circulating relationship. The circulating relationship will be explained with reference to FIG. 12.

The screen 710 displays a plurality of objects 720, 725, 730, 735 having different depth values from each other. A user hand is on a hypothetical line 745. A visual feedback may be provided to distinguish the object 720 in the front of the display from the rest of the plurality of objects 725, 730, 735 in response to the motion of the user's hand. The visual feedback may include highlighting the object 720. For instance, the visual feedback may include changing brightness, transparency, colors, sizes, and shapes of at least one from among the object 720 and the other objects 725, 730, 735.

The object 720 has a maximum depth value, the object 725 has a second-largest depth value, the object 730 has a third-largest depth value, and the object 735 has a minimum depth value. The object 720 is in front of the other objects and the object 735 is behind all the other objects. As a user moves a hand, the control unit may control at least one selected object depth value. Also, if at least one object is selected, the control unit may control the depth value of the selected object so that the selected object is placed in front of the other objects.

For instance, the object 720 has a depth value of 40, the object 725 has a depth value of 30, the object 730 has a depth value of 20, and the object 735 has a depth value of 10. If a user moves a hand to a hypothetical line 750, the object 725 having a second-largest depth value is selected, the depth value changes from 30 to 40, and the object 725 may be placed in front of the other objects. Also, if the control unit controls the depth value of the selected object, the control unit may control the depth values of the other objects according to the circulating relationship. The depth value of the object 720 may change from 40 to 10, the depth value of the object 730 may change from 20 to 30, and the depth value of the object 735 may change from 10 to 20. If a user moves a hand to a hypothetical line 755, the object 730 is selected, the depth value of the object 730 changes from 30 to 40, and the object 730 is placed in front of the other objects. The depth value of the object 725 changes from 40 to 10, the depth value of the object 735 changes from 20 to 30, and the depth value of the object 720 changes from 10 to 20.

If a user keeps moving a hand to a hypothetical line 760, the object 735 is selected, and the depth value of the object 735 changes from 30 to 40, and the object 735 is placed in front of the other objects. The depth value of the object 730 changes from 40 to 10, the depth value of the object 720 changes from 20 to 30, and the depth value of the object 725 changes from 10 to 20. The plurality of objects 720, 725, 730, 735 form a hypothetical ring according to the depth values. If at least one object is selected, the selected object is displayed in front of the other objects, and the other objects are displayed in an order of the hypothetical ring. Forming a hypothetical ring according to the depth values indicates that the depth values change in an order of 40, 10, 20, 30, 40, 10 . . . , etc.

The plurality of objects may form a circulating relationship or a hypothetical ring according to the depth values, which will be explained below with reference to FIG. 12.

If a user moves a hand from the hypothetical line 745, to the hypothetical line 750, to the hypothetical line 755, and to the hypothetical line 760, the depth value of the object 720 changes in an order of 40, 10, 20, 30. The depth value of the object 725 changes in an order of 30, 40, 10, 20. The depth value of the object 730 changes in an order of 20, 30, 40, 10. The depth value of the object 735 changes in an order of 10, 20, 30, 40. As a user moves a hand, the depth values of the plurality of objects 720, 725, 730, 735 changes to have a circulating relationship in an order of 40, 10, 20, 30, 40, 10 . . . , etc.

The control unit may highlight at least one selected object. If a user moves a hand and selects the object 725, the control unit may highlight the object 725.

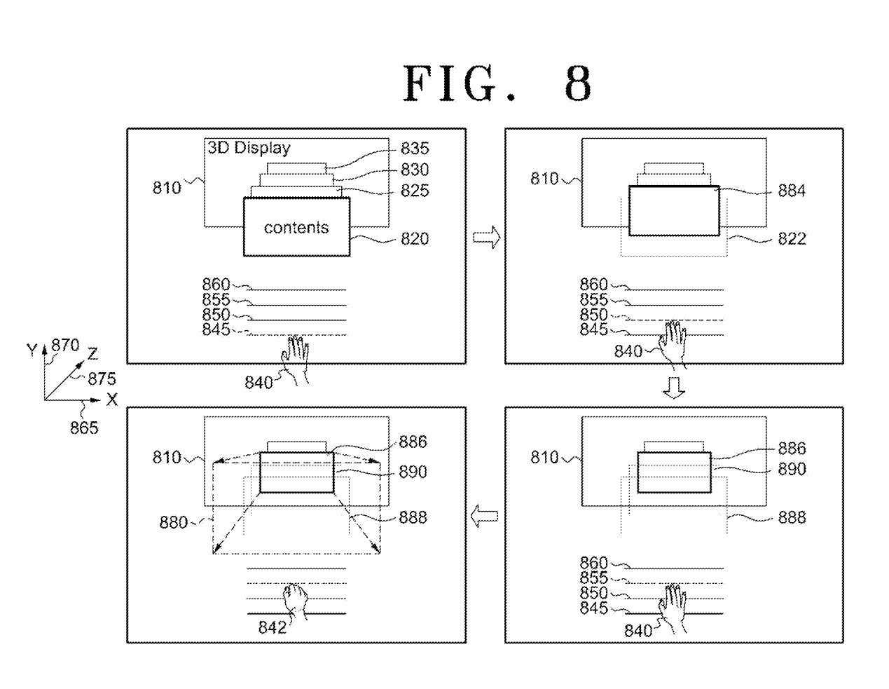

FIG. 8 illustrates changes in objects having different depth values from each other on a screen. A screen 810 displays the objects 820, 825, 830, 835 having different depth values from each other. The object 820 has a maximum depth value and the object 835 has a minimum depth value. If a user places a hand 840 on a hypothetical line 845, the object 820 is selected and highlighted. If a user moves the hand in the z-axis 875 to the hypothetical line 850, the object 825 is selected. The control unit changes transparency of the object having a depth value larger than the depth value of the selected object. If the object 825 is selected, the object 884 which represents object 825 is highlighted, and transparency of the object 822 which represents object 820 having a larger depth value than the object 825 changes. If a user moves a hand to the hypothetical line 855, the object 886 is selected and highlighted, and transparency of the object 888 and 890 having a larger depth value than the object 886 changes.

The control unit senses a shape of a user hand. If the shape changes, the control unit may control functions related to the selected object. For instance, if a user moves a hand to the hypothetical line 855, the object 886 is selected. If a user changes the hand shape, such as to form a first 842, the control unit senses changes in the hand's shape and enlarges and displays 880 which is the selected object 886. For example, if a user's hand gestures a ‘paper’ motion, the control unit selects the object 886, and if a user's hand gestures a ‘rock’ motion, the control unit controls functions related to the object. Functions related to the object 886 may include enlarging and displaying, playing contents related to the object 886, performing functions related to the object 886, and selecting channels related to the object 886.

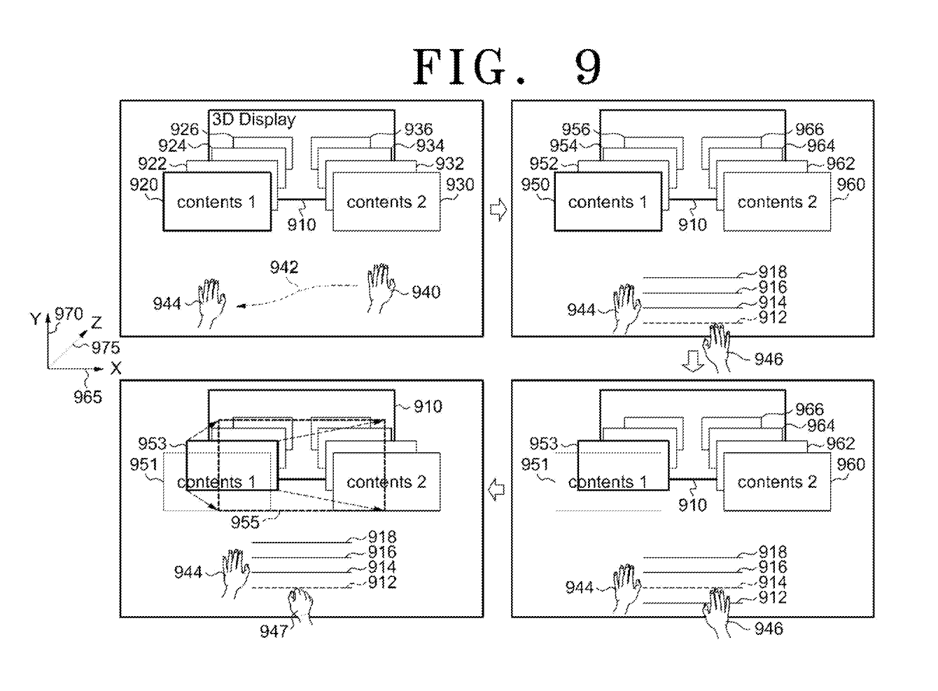

FIG. 9 illustrates a 3D display screen having a plurality of object groups selected according to a user motion.

In FIG. 9, a screen displays a plurality of objects 920, 922, 924, 926, 930, 932, 934, 936 having different depth values from each other. The depth values of the plurality of objects 920, 922, 924, 926, 930, 932, 934, 936 are different from each other. The plurality of objects may form at least 2 groups. The screen 910 forms and displays one group of the plurality of objects 920, 922, 924, 926. Also, the screen 910 forms and displays another group of the plurality of objects 930, 932, 934, 936. Still other plurality of objects (not illustrated) may be displayed on the screen 910 as another group. The screen may display at least two groups simultaneously.

The control unit measures user motion distance in the x-axis 965 and in the y-axis 970 according to a user motion by utilizing outputs of the motion detecting unit, and selects at least one of the above plurality of groups in response to the user motion distance in the x and y axes. For instance, the screen 910 forms and displays a first group of the plurality of objects 920, 922, 924, 926, and a second group of the plurality of objects 930, 932, 934, 936. A user's hand is placed in front of the second group 940. If a user moves a hand to the left side 942 and in front of the first group 944, the first group is selected. The object 920 of the first group may be highlighted to deliver a selecting mode to the user. If a user puts one hand 944 in front of the first group and moves the other hand 946 in the z-axis 975, the objects 950, 952, 954, 956 of the first group may be selected. If a user places a hand 946 on a hypothetical line 912, the object 950 may be selected. If a user places the hand 946 on a hypothetical line 914, the object 952 may be selected. If a user places the hand 946 on a hypothetical line 916, the object 954 may be selected. If a user places the hand 946 on a hypothetical line 918, the object 956 may be selected. In the following cases, a user places the other hand 944 in front of the first group. If a user moves a hand from the hypothetical line 912 to the hypothetical line 914, the object 951 changes into a transparent mode and the object 953 is selected and highlighted. If a user changes the shape of the hand 947 when selecting the object 953, and moves the hand 947 to the hypothetical line 912, the control unit may sense the changing and moving and display the enlargement 955 of the object 953. Also, even if a user does not move the hand 947, the control unit may sense the changing and display the enlargement 955 of the object 953. Changes in hand shape include any one of scissor, rock, paper gestures and shaking of a hand.

The control unit of the 3D display system measures user motion distance in the x and y axes according to a user motion with respect to the display by utilizing outputs from the motion detecting unit, and selects at least one of the plurality of groups in response to the user motion distance in the x and y axes with respect to the display. Also, the control unit measures user motion distance in the z-axis according to a user motion with respect to the display by utilizing output from the motion detecting unit and selects at least one of the plurality of objects in the selected group in response to the user motion distance in the z-axis with respect to the display. Also, the control unit measures user motion distance in the x-axis 965 and y-axis 970 according to a user motion by moving one hand, and measures user motion distance in the z-axis according to a user motion by moving the other hand. If a user moves one hand, the control unit measures the user motion distance in the x-axis 965 and y-axis 970 in response to the hand movement. The control unit may select any one of the plurality of groups in response to the user motion distance in the x and y axes. When selecting one group, the control unit may measure the movement of the other hand. The control unit measures the user motion distance in the z axis by moving the other hand, and select any one of the plurality of objects having different depth values from each other included in the selected group.

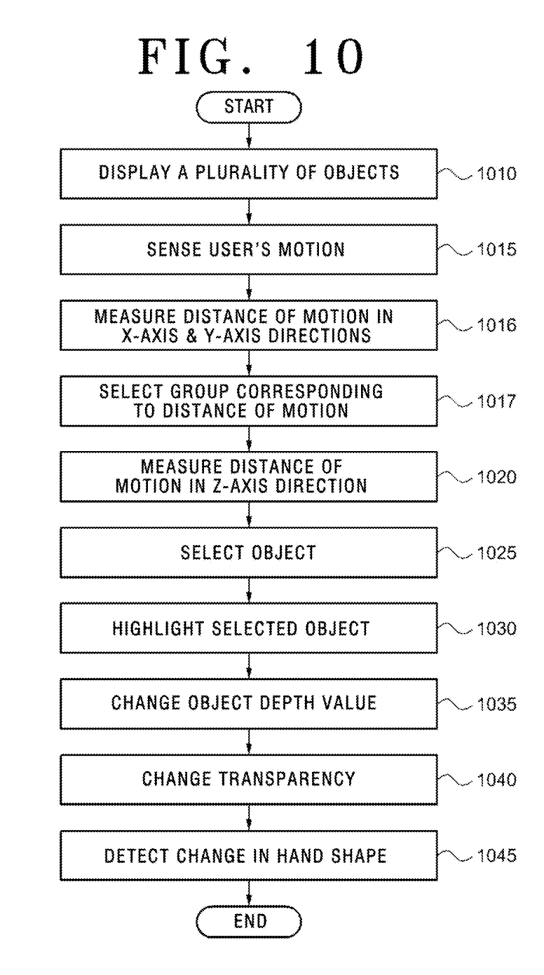

FIG. 10 illustrates a flowchart of selecting any one of the plurality of objects displayed on a screen. A 3D display method may include displaying the plurality of objects having different depth values on the screen (S1010), sensing the movement of a user with respect to the screen (S1015), measuring user motion distance in the z-axis according to a user motion (S1020) with respect to the screen, and selecting at least one of the plurality of objects having different depth values on the screen in response to the measured user motion distance in the z-axis (S1025).

Selecting at least one of the plurality of objects may include selecting at least one 3D object from the plurality of objects in proportion to the user motion distance in the z axis and z direction of a user motion. The selecting of at least one of the plurality of objects may also include controlling a depth value of the selected object, using a control function 1035 so that the selected object is displayed in front of the other plurality of objects. The plurality of objects may have circulating relationship according to depth values, and if the depth value of the selected object is controlled, the selecting at least one of the plurality of objects may include controlling the depth values of the other objects according to the circulating relationship.

The 3D display method may include highlighting the selected object (S1030). Also, the method may include changing transparency of the selected object, and changing transparency of the object having a larger depth value than the selected object (S1040).

The 3D display method may include sensing changes in hand shape of a user, and performing functions related to the selected object according to the changes in hand shape (S1045).

In the 3D display method, the plurality of objects may form at least two groups, and the method may additionally include displaying the above groups simultaneously on the screen, measuring user motion distance in the x and y axes by utilizing the sensed user movement according to a user motion (S1016), and selecting at least one of the above groups in response to the user motion distance in the x and y axes (S1017).

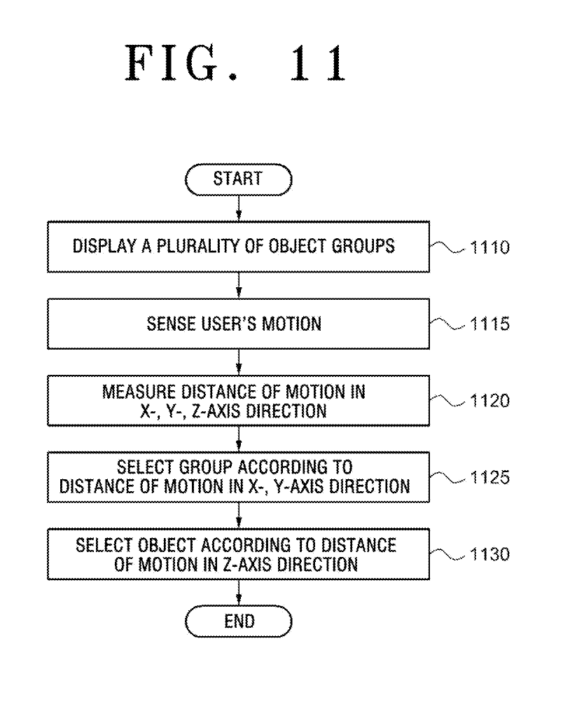

FIG. 11 is a flowchart illustrating an operation of selecting one object from among a plurality of objects displayed in two or more groups on the screen according to the user motion. The 3D display method may include displaying a plurality of object groups simultaneously in which each of the plurality of object groups includes a plurality of objects having different depth values from each other (S1110), sensing a user movement with respect to the screen (S1115), measuring a user motion distance in the x, y, and z axes according to a user motion (S1120) with respect to the screen, selecting at least one group from the plurality of groups in response to the user motion distance in the x and y axes (S1125), and selecting at least one from the plurality of objects of the selected object groups in response to the user motion distance in the z axis (S1130) with respect to the screen.

The 3D display method may include measuring user motion distance in the x and y axes with respect to the screen by moving one hand of a user according to a user motion, and measuring user motion distance in the z axis with respect to the screen by moving the other hand of a user according to a user motion.

FIG. 12 illustrates an example of circulating relationship according to depth values of the plurality of objects.

In a first case 1210 illustrated in FIG. 12, object A has a depth value “a”, object B has a depth value “b”, object C has a depth value “c”, object D has a depth value “d”, and object E has a depth value “e”. It is assumed that the screen has a depth value “0”. In the first case 1210, object A has a maximum depth value and object D has a minimum depth value. If a user moves and selects object B, depth values of the objects A, B, C, D, E change according to the circulating relationship. For instance, if a user selects object B in the first case 1210, the objects move into the position illustrated in the second case 1220.

In the second case 1220, the selected object B has a maximum depth value, “a”, and the object A, which had maximum depth value in the first case 1210, has a minimum depth value, “e”. The depth values of the objects A, B, C, D, E increases or decreases according to the circulating relationship. Specifically, the depth value of the object C increases from “c” to “b”, the depth value of the object D increase from “d” to “c”, and the depth value of the object E increases from “e” to “d.” If a user moves and selects the object E in the second case 1220, the objects illustrated in the second case 1220 change position as illustrated in the third case 1230.

In the third case 1230, the selected object E has a maximum depth value, “a”, and the object D, which has a larger depth value than the object E in the second case 1220, has a minimum depth value, “e”. Since the depth values of the objects A, B, C, D, E are controlled by circulating relationship, the depth value of the object A increases from “e” to “b”, the depth value of the object B decreases from “a” to “c”, and the depth value of the object C decreases from “b’ to “d”.

According to exemplary embodiments, every object forms a hypothetical ring by selecting an object despite maximizing the depth values of the selected object.

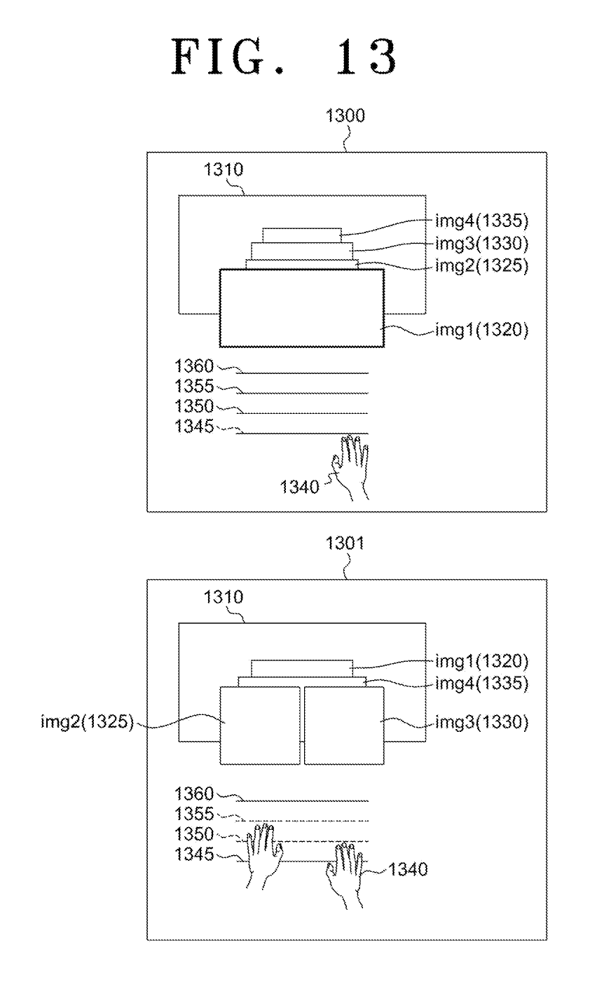

FIG. 13 illustrates other overviews including a screen and a plurality of objects according to a user motion.

In FIG. 13, objects 1320, 1325, 1330, 1335 have different depth values from each other on a screen 1310. A user hand is placed on a hypothetical line 1345. If a user moves one hand 1340 to the hypothetical line 1345 and moves the other hand 1342 to the hypothetical line 1355, two objects 1325, 1335 may be selected simultaneously. The selected two objects 1325, 1330 may be simultaneously displayed in front of the other objects. The other hand 1342 may be the other hand of a user or may be a hand of another user. The two users may select each object from the plurality of objects 1320, 1325, 1330, 1335, and thus, may select two objects simultaneously.

Methods according to exemplary embodiments may be implemented in the form of program commands to be executed through a variety of computing forms and recorded on a computer-readable medium. The computer-readable medium may include a program command, data files, or a data structure singularly or in combination. The program commands recorded on said medium may be designed and constructed specifically for the exemplary embodiments, or those which are known and available among those skilled in the computer software area. The computer-readable media may be magnetic media such as a hard disk, a floppy disk and a magnetic tape, optical media such as CD-ROM and DVD, magneto-optical media such as floppy disks, optical disks, and a hardware apparatus storing and performing program commands such as ROM, RAM, and flash memory. The program commands may include high-level language code utilized by an interpreter and implemented by a computer as well as machine code made by a compiler. The hardware apparatus may function as at least one software module to perform functions of the exemplary embodiments, and vice versa.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A three dimensional (3D) display system, comprising:
a screen which displays a plurality of objects with different depth values from each other, the plurality of objects having a circulating relationship according to the different depth values thereof;
a motion detecting unit which senses a user motion with respect to the screen; and
a control unit which measures a user motion distance in a z-axis direction with respect to the screen according to the user motion, using an output from the motion detecting unit, selects one object among the plurality of objects in accordance with the measured user motion distance in the z-axis direction, controls a depth value of the one selected object so that the one selected object is displayed in front of the plurality of objects on the screen, and controls the depth values of a rest of the plurality of objects according to the circulating relationship.

2. A three dimensional (3D) display system, comprising:
a screen which displays a plurality of objects with different depth values from each other;
a motion detecting unit which senses a user motion with respect to the screen; and
a control unit which measures a user motion distance in a z-axis direction with respect to the screen according to the user motion, using an output from the motion detecting unit, and selects at least one object among the plurality of objects in accordance with the measured user motion distance in the z-axis direction.

3. The 3D display system of claim 2, wherein the control unit selects the at least one object among the plurality of objects according to the measured user motion distance in the z-axis direction according to the user motion.

4. The 3D display system of claim 3, wherein the control unit controls the depth value of the at least one selected object.

5. The 3D display system of claim 3, wherein the control unit controls the depth value of the at least one selected object so that the at least one selected object is displayed in front of the plurality of objects on the screen.

6. The 3D display system of claim 2, wherein the plurality of objects have a circulating relationship according to the depth values thereof, and if the control unit controls the depth value of the at least one selected object, the control unit controls the depth values of a rest of the plurality of objects according to the circulating relationship.

7. The 3D display system of claim 2, wherein the control unit highlights the at least one selected object.

8. The 3D display system of claim 2, wherein the control unit changes a transparency of the at least one selected object, or changes the transparency of the plurality of objects which have the greater depth value than the at least one selected object.

9. The 3D display system of claim 2, wherein the control unit detects a change in a user's hand shape, and performs an operation related to the selected object according to the change in the user's hand shape.

10. The 3D display system of claim 9, wherein the control unit selects the object if the user's hand shape is gesturing a first sign, and performs an operation related to the selected object if the user's hand shape is gesturing a second sign different from the first sign.

11. The 3D display system of claim 2, wherein the plurality of objects form two or more groups, the screen displays the two or more groups concurrently, and the control unit measures a user motion distance in x-axis and y-axis directions according to the user motion, using an output from the motion detecting unit, and selects at least one group among the two or more groups according to the measured user motion distance in the x-axis and y-axis directions.

12. A three dimensional (3D) display system, comprising:
a screen which displays a plurality of object groups concurrently, the plurality of object groups each including a plurality of objects having different depth values from each other;
a motion detecting unit which senses a user motion with respect to the screen; and
a control unit which measures a user motion distance in x-axis and y-axis directions with respect to the screen according to the user motion, using an output from the motion detecting unit, selects one group among the plurality of object groups according to the measured user motion distance in the x-axis and y-axis directions, measures a user motion distance in a z-axis direction according to the user motion, using an output from the motion detecting unit, and selects at least one object among the plurality of objects of the selected object group according to the measured user motion distance in the z-axis direction.

13. The 3D display system of claim 12, wherein the control unit calculates the user motion distance in the x-axis and y-axis directions according to a motion of one hand of the user, and measures the user motion distance in the z-axis direction according to the user motion based on a motion of the other hand of the user.

14. A three dimensional (3D) display method, comprising:
displaying a plurality of objects on a screen with different depth values from each other;
sensing a user motion with respect to the screen; and
measuring a user motion distance in a z-axis direction with respect to the screen according to the user motion, and selecting at least one object among the plurality of objects in accordance with the measured user motion distance in the z-axis direction.

15. The 3D display method of claim 14, wherein the selecting the at least one object comprises selecting the at least one object among the plurality of objects in proportion to the measured user motion distance in the z-axis direction according to the user motion.

16. The 3D display method of claim 15, further comprising controlling the depth value of the at least one selected object.

17. The 3D display method of claim 15, further comprising controlling the depth value of the at least one selected object so that the selected object is displayed in front of the plurality of objects on the screen.

18. The 3D display method of claim 14, wherein the plurality of objects have a circulating relationship according to the depth values thereof, and if the depth value of the at least one selected object is controlled, further comprising controlling the depth values of a rest of the plurality of objects according to the circulating relationship.

19. The 3D display method of claim 14, comprising highlighting the at least one selected object.

20. The 3D display method of claim 14, comprising changing a transparency of the at least one selected object, or changing the transparency of the plurality of objects which have a greater depth value than that of the at least one selected object.

21. The 3D display method of claim 14, further comprising detecting a change in a user's hand shape, so that an operation related to the selected object is performed.

22. The 3D display method of claim 21, further comprising selecting the object if the user's hand shape is gesturing a first sign, and performing an operation related to the selected object if the user's hand shape is gesturing a second sign different from the first sign.

23. The 3D display method of claim 14, wherein the plurality of objects form two or more groups, and further comprising:
displaying the two or more groups concurrently on the screen,
measuring a user motion distance in x-axis and y-axis directions with respect to the screen according to the sensed user motion; and
selecting at least one group among the two or more groups according to the measured user motion distance in the x-axis and y-axis directions.

24. A three dimensional (3D) display method, comprising:
displaying on a screen a plurality of object groups concurrently, the plurality of object groups each including a plurality of objects having different depth values from each other;
sensing a user motion with respect to the screen;
measuring a user motion distance in x-axis and y-axis directions with respect to the screen according to the sensed user motion;
selecting one group among the plurality of object groups according to the measured user motion distance in the x-axis and y-axis directions; and
selecting at least one object among the plurality of objects of the selected object group according to the measured user motion distance in a z-axis direction.

25. The 3D display method of claim 24, comprising:
measuring the user motion distance in the x-axis and y-axis directions with respect to the screen according to the user motion based on a motion of one hand of the user; and
measuring the user motion distance in the z-axis direction with respect to the screen according to the user motion based on a motion of the other hand of the user.

26. The 3D display system of claim 1, wherein the motion detecting unit comprises a remote controller including an inertial sensor or an optical sensor.

27. The 3D display system of claim 1, wherein the motion detecting unit comprises a vision sensor.

28. The 3D display system of claim 27, wherein the vision sensor is provided as an attached module to the 3D display system.

29. The 3D display system of claim 2, wherein the motion detecting unit comprises a remote controller including an inertial sensor or an optical sensor.

30. The 3D display system of claim 2, wherein the motion detecting unit comprises a vision sensor.

31. The 3D display system of claim 30, wherein the vision sensor is provided as an attached module to the 3D display system.
